(19) United States
(12) Patent Application Publication
(10) Pub. No.: US 2024/0109155 A1
(43) Pub. Date: Apr. 4, 2024

(54) Scale Removal Tool For Cutting Machines

(71) Applicant: Michael J. MARX, White Lake, MI (US)

(72) Inventor: Michael J. MARX, White Lake, MI (US)

(21) Appl. No.: 18/461,615

(22) Filed: Sep. 6, 2023

Related U.S. Application Data
(60) Provisional application No. 63/411,174, filed on Sep. 29, 2022.

(51) Int. Cl. B23K 26/70; B23K 37/04

(52) U.S. Cl. CPC B23K 26/702; B23K 37/0461

(57) ABSTRACT

A debris removal tool for removing debris from a first slat and a second slat includes a housing and a handle coupled to a base wall of the housing. A first axle is disposed on a second side of the housing. A first slat engagement mechanism is disposed on the first axle engaging the first slat. A second slat engagement mechanism is disposed on the first axle spaced apart from the first slat engagement and engaging the second slat.

### CROSS-REFERENCE TO RELATED APPLICATION

This application claims the benefit of U.S. Provisional Application No. 63/411,174, filed on Sep. 29, 2022. The entire disclosure of the above application is incorporated herein by reference.

### FIELD

The present disclosure relates to a cutting machine and, more particularly, to a scale removal tool for the cutting machine.

### BACKGROUND

During laser cutting of metal, the metal to be formed is placed on slats of a cutting table. The cutting process generates slag, scale or other debris that attaches itself to the top of the slats. The attached debris is unwanted and can interfere with the proper operating and alignment during operation of the system. Thus, a way to remove the slag, scale or debris safely and quickly is needed.

### SUMMARY

This section provides a general summary of the disclosure and is not a comprehensive disclosure of its full scope or all of its features.

In one aspect of the disclosure, a debris removal tool for removing debris from a first slat and a second slat includes a housing and a handle coupled to a base wall of the housing. A first axle is disposed on a second side of the housing. A first slat engagement mechanism is disposed on the first axle engaging the first slat. A second slat engagement mechanism is disposed on the first axle spaced apart from the first slat engagement and engaging the second slat.

In another aspect of the disclosure, a debris removal tool for removing debris from a first slat and a second slat includes a housing comprising a base wall, a first side wall, and a second side wall, a handle coupled to the housing and a first axle. A first removal wheel is disposed on the first axle, a second removal wheel is disposed on the first axle, a third removal wheel is disposed on the first axle, and a fourth removal wheel disposed on the first axle. A first spacer is disposed on the first axle between the first side wall and the first removal wheel. A second spacer is disposed between the second removal wheel and the third removal wheel. A third spacer is disposed between the fourth removal wheel the second side wall. A first intermediate spacer is disposed between the first removal wheel and the second removal wheel. A second intermediate spacer is disposed between the third removal wheel and the fourth removal wheel.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a perspective view of a cutting table having a tool disposed relative thereto.

FIG. 2 is a perspective view of the removal tool.

FIG. 3 is an underside perspective view of the removal tool with a single removal head.

FIG. 4 is a top view of a dual removal head tool.

FIG. 5 is an enlarged underside view of the dual removal head tool.

FIG. 6 is a top view of damaged slats.

FIG. 7 is a top view of the slats of FIG. 6 being processed by the removal tool.

Corresponding reference numerals indicate corresponding parts throughout the several views of the drawings.

### DETAILED DESCRIPTION

Example embodiments will now be described more fully with reference to the accompanying drawings.

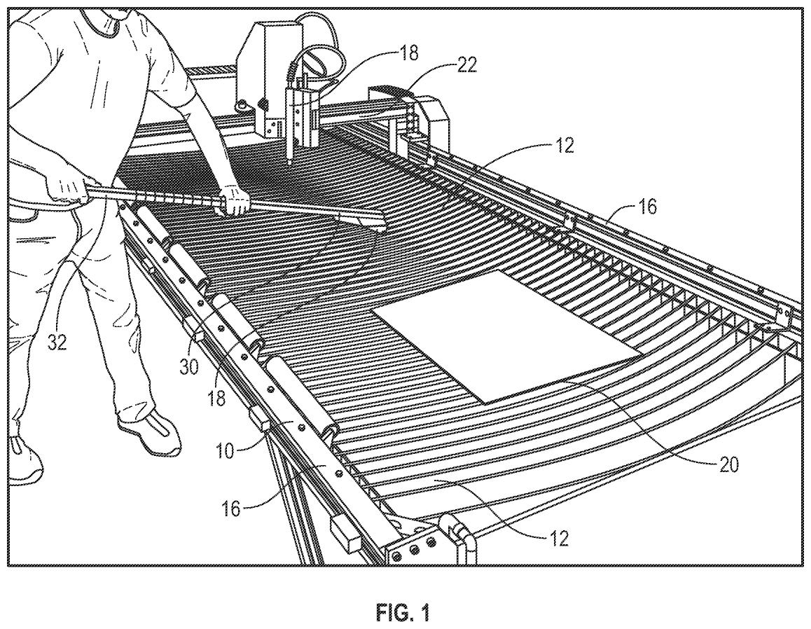

FIG. 1 is perspective view of a cutting table 10 having a plurality of slats 12 having scale or slag as attached debris 14 thereon. The slats 12 are secured above a coolant positioned in the table 10 in a spaced part manner. Spaces S are generally uniform laterally across the table. In this example, the slats 12 extend between opposite sides 16 and have a distance D therebetween. The side rails 16 guide the longitudinal path of a cutting head 18 above material 20 to be cut. A rail 22, coupled to the head 18, guides the head 18 laterally above the material 20. A removal tool 30, in a first example, is illustrated.

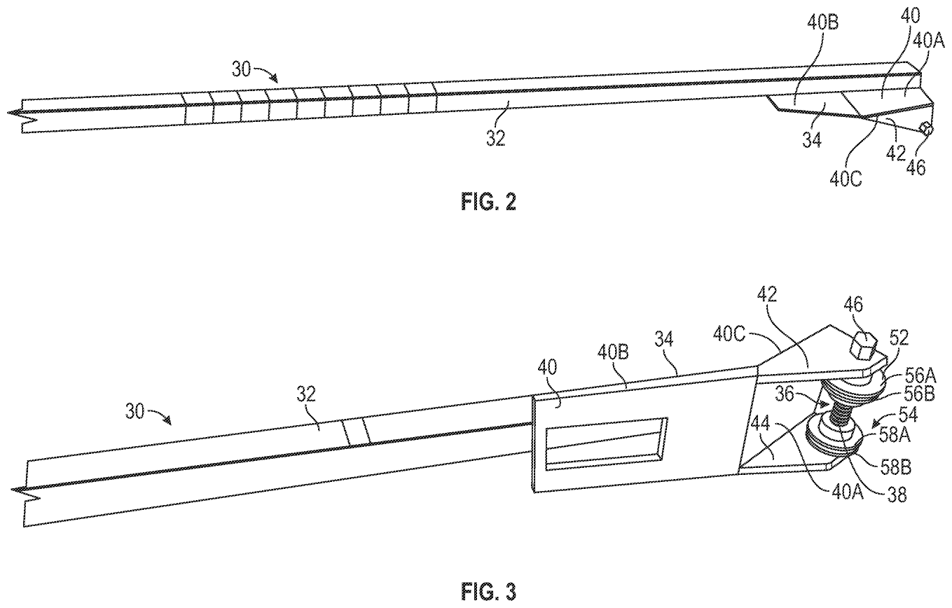

Referring now also to FIGS. 2 and 3, the removal tool 30 is shown. The removal tool 30 has a handle 32 that is coupled to a housing 34. A removal head 36 is illustrated coupled to the housing 34. The removal head 36 in this example is a single removal head disposed on the housing 34. The single removal head 36 has a single axle 38 defining an axis of rotation of the removal head 36.

The housing 34 has a base wall 40. In this example, the base wall 40 has a first portion 40A and a second portion 40B. The first portion 40A and the second portion 40B are disposed at an angle relative to each other. One or both of the portions 40A and 40B secure the handle 32 thereto. The first portion 40A of the side wall 40 has longitudinal edges 40C. The edges 40C have a first side wall 42 and a second side wall 44 extending therefrom. The first axle 38 extends between the first side wall 42 and the second side wall 44. In this example, the first axle 38 is a bolt having a head 46 and a nut 48 securing the axle 38 between the first side wall 42 and the second side wall 44. Other types of axles 38, as well as different types of securing means other than head 46 and a nut 48, may be used. In the example illustrated in FIGS. 2 and 3, the removal head 36 has a first slat engagement mechanism 52 and a second slat engagement mechanism 54. The first slat engagement mechanism 52 and the second slat engagement mechanism 54 are spaced apart by the D so that each engage the slats 12. The first slat engagement mechanism 52 has a first removal wheel 56A and a second removal wheel 56B. The second slat engagement mechanism 54 has a first removal wheel 58A and a second removal wheel 58B.

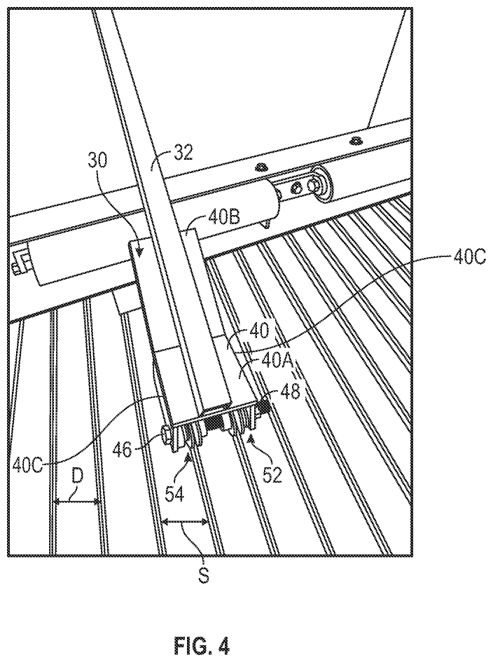

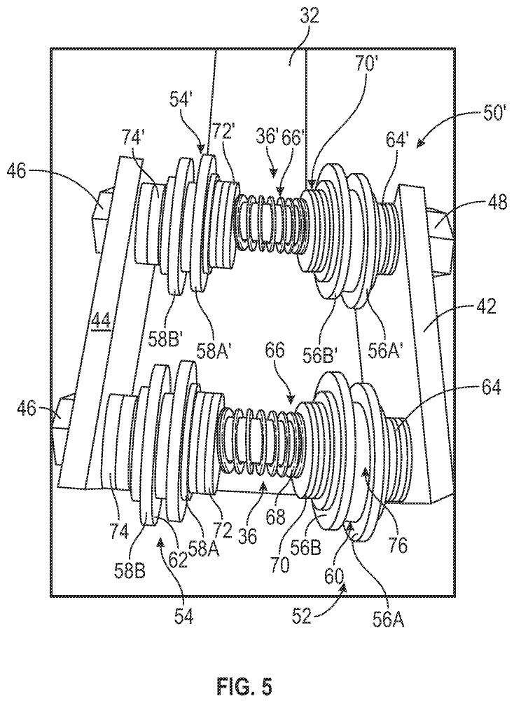

Referring now also to FIGS. 4 and 5, the removal too 301 may include a second removal head 36′. The second removal head 36′ is configured in a similar manner to the removal head 36. In the illustration, the second removal head 36′ and its associated components are referred to with a prime (′), however, only the first removal head and its operation will be described. The first removal head 36 includes the first slat engagement members 52 and 54. The first slat engagement member 52 comprises a pair of removal wheels 56A, 56B. The removal wheels 56A, 56B are spaced apart by an intermediate spacer 60. The second removal wheels 58A, 58B are spaced apart by a second intermediate spacer 62. The first intermediate spacer 60 and the second intermediate spacer 62 receive the slats 12 adjacent thereto and are therefore are spaced apart by the distance D

The first slat engagement member 52 and the second slat engagement member 54 are laterally positioned relative to the first side wall 42 and the second side wall 44 by a plurality of spacers. In this example, a first spacer 64 is positioned between the first side wall 42 and the first slat engagement members 52. In particular, the first spacer 64 is positioned between the first sidewall 42 and the removal wheel 56A.

A second spacer 66 is positioned between the first slat engagement member 52 and the second slat engagement member 54. The second spacer 66 comprises a spring 68 that is used to conformably position the removal wheels 56B and 58A. That is, the spring 68 allows lateral movement of the removal wheel 56B and the removal wheel 58A to account for imperfections in the distance D and the presence of slag or other debris on the slats 12. The spring 68 may extend between the first intermediate spacer 70 and a second intermediate spacer 72. The intermediate spacers 70 and 72 may formed of disks that are urged against the removal wheels 56B, 58A by the spring 68. The disks may be a metal, a polymer or a combination thereof. The intermediate spacers 70, 72 and the spring may be coaxial with the axle 38.

A third spacer 70 is disposed between the removal wheel 58B and the second side 44. The first spacer 64 and the third spacer 70 may be formed of a cylinder or a plurality of disks coaxial with the axle 38. In one example, a plurality of washers was used. The spacers 64, 70 may be formed of metal or self-lubricated polymer such as nylon, (or combinations thereof). That is, the portion of the spacers touching the side walls or the first slot engagement mechanism or the second slot engagement mechanism may be nylon or metal. The spacers may also be high strength steel.

The removal wheels 56A, 56B, 56A′, 56B′, 58A, 58B, 58A′, 58B′ may be formed of various materials including but not limited to high strength steel. The removal wheels 56A, 56B, 56A′, 56B′, 58A, 58B, 58A′, 58B′ may be formed and patterned with a pattern 76 that acts like a file. The inside surfaces of the removal wheels that are positioned adjacent to the slats 12 may have the pattern 76 disposed thereon. Of course, the pattern may be provided across each entire wheel 56, 58.

The axles 38, 38′ may be formed of a bolt, such as ⅜ inch or a ⅝ inch bolt. A dedicated cylindrical axle may be formed to size and secured to the housing at each end such as by pins or the like.

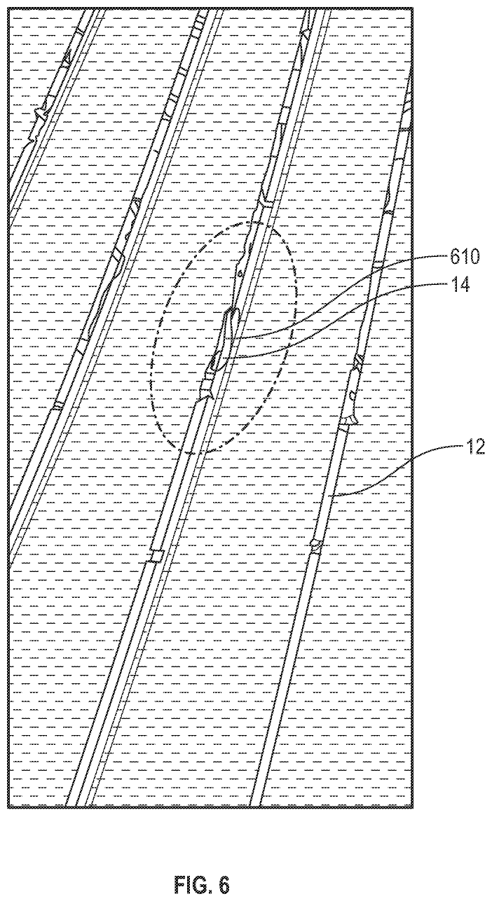

In operation, the slats 12 illustrated in FIG. 1 are slightly curved. The straight nature or longitudinal nature of the removal wheels 56A, 56B, 58A, 58B allow the inside edges adjacent to the intermediate spacers 60,62 to contact the edges of the slats illustrated in FIG. 6. FIG. 6 has a circled area that has slag 610 disposed thereon.

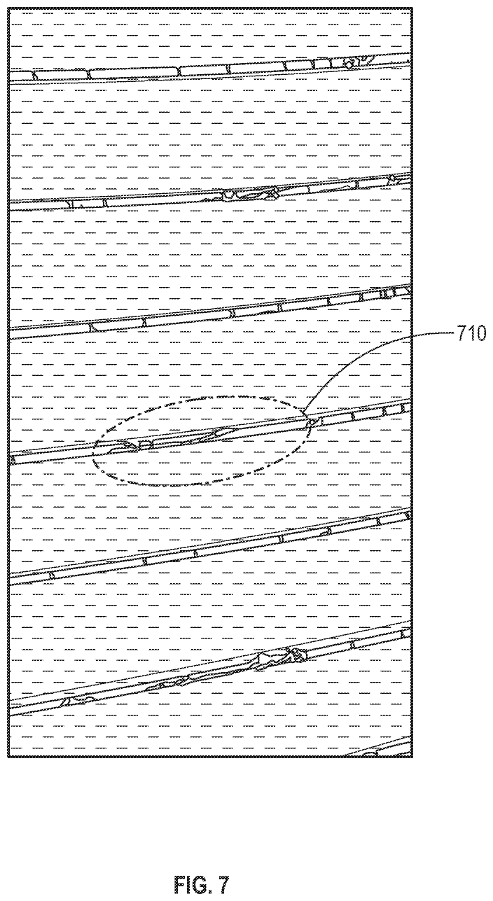

The slag 610 is one form of debris. After the processing tool has been used on two adjacent slats 12, the area may be cleaned as illustrated in 710 of FIG. 7.

In operation, the gaps between the large diameter removal wheel are aligned to receive the top edge of the slats. A force is applied by way of the handle 32 to push the tool across the slats 12. The handle 32 may be sized to allow the entire length of the slats to be reached from one side of the cutting table 10. As the tool 30 is moved the edges of the removal wheels 56A, 56B, 58A, 58B, 56A′, 56B′, 58A′ and 58B′ are scraping slag, scale or debris. Straightening or reforming the edge of the slats may also take place as the removal wheels 56A, 56B, 58A, 58B push thereon.

The foregoing description of the embodiments has been provided for purposes of illustration and description. It is not intended to be exhaustive or to limit the disclosure. Individual elements or features of a particular embodiment are not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A debris removal tool for removing debris from a first slat and a second slat comprising:
a housing;
a handle coupled to a base wall of the housing;
a first axle disposed on a second side of the housing;
a first slat engagement mechanism disposed on the first axle engaging the first slat; and
a second slat engagement mechanism disposed on the first axle spaced apart from the first slat engagement and engaging the second slat.

2. The debris removal tool of claim 1 wherein the housing comprises a first side wall extending from the base wall and a second side wall extending from the base wall and spaced apart from the first side wall, said axle coupled to the first side wall and the second side wall.

3. The debris removal tool of claim 2 wherein the first wall and the second wall are longitudinally extending.

4. The debris removal tool of claim 2 further comprising a first spacer disposed between the first side wall and the first slat engagement mechanism; a second spacer disposed between the first slat engagement mechanism and the second slat engagement mechanism, and a third spacer disposed between the second slat engagement mechanism and the second side wall.

5. The debris removal tool of claim 4 wherein the first spacer, second spacer and third spacer are disposed on the first axle.

6. The debris removal tool of claim 5 wherein the second spacer comprises a spring disposed around the first axle.

7. The debris removal tool of claim 6 wherein the spring is disposed between a first intermediate spacer and a second intermediate spacer.

8. The debris removal tool of claim 5 wherein the first spacer comprises a first disk, and the third spacer comprises a third disk.

9. The debris removal tool of claim 5 wherein the first slat engagement mechanism comprises a first removal wheel and a second removal wheel spaced apart from the first removal wheel.

10. The debris removal tool of claim 9 wherein the first slat engagement mechanism comprises a first removal spacer disposed between the first removal wheel and the second removal wheel.

11. The debris removal tool of claim 10 wherein the second slat engagement mechanism comprises a third removal wheel and a fourth removal wheel spaced apart from the third removal wheel by a second removal spacer.

12. The debris removal tool of claim 11 wherein the first removal wheel, the second removal wheel, the third removal wheel and the fourth removal wheel are formed of high strength material.

13. The debris removal tool of claim 1 further comprising a second axle disposed on the second side of the housing, a third slat engagement mechanism disposed on the second axle engaging the first slat and a fourth slat engagement mechanism disposed on the second axle spaced apart from the third slat engagement mechanism and engaging the second slat.

14. A debris removal tool for removing debris from a first slat and a second slat comprising:
a housing comprising a base wall, a first side wall, and a second side wall;
a handle coupled to the housing;
a first axle;
a first removal wheel disposed on the first axle,
a second removal wheel disposed on the first axle;
a third removal wheel disposed on the first axle;
a fourth removal wheel disposed on the first axle;
a first spacer disposed on the first axle between the first side wall and the first removal wheel;
a second spacer disposed between the second removal wheel and the third removal wheel;
a third spacer disposed between the fourth removal wheel the second side wall;
a first intermediate spacer disposed between the first removal wheel and the second removal wheel; and
a second intermediate disposed between the third removal wheel and the fourth removal wheel.

15. The debris removal tool of claim 14 wherein the base wall has a first longitudinal edge and a second longitudinal edge, said first side wall extending from the first longitudinal edge and edge.

16. The debris removal tool of claim 14 wherein the first removal wheel, the second removal wheel, the third removal wheel and the fourth removal wheel comprise high strength steel.

17. The debris removal tool of claim 14 wherein the handle is coupled to the base wall.

18. The debris removal tool of claim 14 wherein the second spacer comprises a spring disposed between a first intermediate spacer and a second intermediate spacer.

19. The debris removal tool of claim 14 wherein the first spacer comprises a first disk, and the third spacer comprises a third disk.

20. The debris removal tool of claim 14 further comprising a second axle disposed on the second side of the housing, a third slat engagement mechanism disposed on the second axle engaging the first slat and a fourth slat engagement mechanism disposed on the second axle spaced apart from the third slat engagement mechanism and engaging the second slat.
